(19) United States
(12) Patent Application Publication
(10) Pub. No.: US 2007/0048595 A1
(43) Pub. Date: Mar. 1, 2007

(54) Batteries

(76) Inventors: Paul Graham, Taunton, MA (US); Richard E. Durkot, East Walpole, MA (US); George Cintra, Holliston, MA (US)

Correspondence Address: FISH & RICHARDSON P.C., P.O. BOX 1022, MINNEAPOLIS, MN, 55440-1022, US

(21) Appl. No.: 11/498,008

(22) Filed: Aug. 1, 2006

Related U.S. Application Data
(60) Provisional application No. 60/711,007, filed on Aug. 24, 2005.

(51) Int. Cl. H01M 10/50; H01M 4/66; H01M 10/04

(52) U.S. Cl. 429/62; 429/245; 29/623.1; 429/50

(57) ABSTRACT

Batteries and related components and methods are disclosed.

### CROSS-REFERENCE TO RELATED APPLICATIONS

This application is a continuation application of and claims priority to U.S. Provisional Application No. 60/711,007, filed on Aug. 24, 2005, which is hereby incorporated by reference.

### TECHNICAL FIELD

The invention relates to batteries, and to related components and methods.

### BACKGROUND

Batteries, such as alkaline batteries, are commonly used as electrical energy sources. Generally, a battery contains a negative electrode (anode) and a positive electrode (cathode). The anode contains an active material (e.g., zinc particles) that can be oxidized; and the cathode contains an active material (e.g., manganese dioxide) that can be reduced. The active material of the anode is capable of reducing the active material of the cathode. In order to prevent direct reaction of the active material of the anode and the active material of the cathode, the electrodes are electrically isolated from each other by a separator.

When a battery is used as an electrical energy source in a device, such as a cellular telephone, electrical contact is made to the electrodes, allowing electrons to flow through the device and permitting the respective oxidation and reduction reactions to occur to provide electrical power. An electrolyte in contact with the electrodes contains ions that flow through the separator between the electrodes to maintain charge balance throughout the battery during discharge.

### SUMMARY

The invention relates to batteries, and to related components and methods.

In one aspect, the invention features a battery including a housing, an anode and a cathode within the housing, and a current collector at least partially disposed in the anode. The current collector includes a fuse having a fusing element with a melting point of at least about 200° C. (e.g., at least about 300° C., at least about 400° C., at least about 500° C., at least about 600° C., at least about 800° C., at least about 1000° C., at least about 1100° C., at least about 1200° C., at least about 1400° C., at least about 1600° C., at least about 1800° C., at least about 1900° C.).

In another aspect, the invention features a battery including a housing, an anode and a cathode within the housing, and a current collector at least partially disposed in the anode. The current collector includes a fuse including a fusing element. The fusing element is adapted to melt at a temperature of at least about 200° C. (e.g., at least about 300° C., at least about 400° C., at least about 500° C., at least about 600° C., at least about 800° C., at least about 1000° C., at least about 1100° C., at least about 1200° C., at least about 1400° C., at least about 1600° C., at least about 1800° C., at least about 1900° C.) while the housing is at a temperature of at most about 90° C. (e.g., at most about 80° C., at most about 70° C., at most about 60° C., at most about 50° C., at most about 40° C., at most about 30° C., at most about 25° C.).

In a further aspect, the invention features a battery including a housing, an anode and a cathode within the housing, and a current collector at least partially disposed in the anode. The current collector includes a fuse having a fusing element with a width or diameter of at most about 1.5 millimeters.

In an additional aspect, the invention features a method of making a battery. The method includes disposing an anode, a cathode, and a current collector into a housing. The current collector includes an elongated body and a fuse at least partially disposed in the elongated body. The fuse includes a fusing element with a melting point of at least about 200° C. (e.g., at least about 300° C., at least about 400° C., at least about 500° C., at least about 600° C., at least about 800° C., at least about 1000° C., at least about 1100° C., at least about 1200° C., at least about 1400° C., at least about 1600° C., at least about 1800° C., at least about 1900° C.).

In a further aspect, the invention features a method of making a battery. The method includes disposing an anode, a cathode, and a current collector into a housing. The current collector includes a fuse including a fusing element. The fusing element is adapted to melt at a temperature of at least about 200° C. (e.g., at least about 300° C., at least about 400° C., at least about 500° C., at least about 600° C., at least about 800° C., at least about 1000° C., at least about 1100° C., at least about 1200° C., at least about 1400° C., at least about 1600° C., at least about 1800° C., at least about 1900° C.) while the housing is at a temperature of at most about 90° C. (e.g., at most about 80° C., at most about 70° C., at most about 60° C., at most about 50° C., at most about 40° C., at most about 30° C., at most about 25° C.).

In an additional aspect, the invention features a method of making a battery. The method includes disposing an anode, a cathode, and a current collector into a housing. The current collector includes an elongated body and a fuse at least partially disposed in the elongated body. The fuse includes a fusing element having a width or diameter of at most about 1.5 millimeters.

In another aspect, the invention features a method that includes flowing a current through a battery. The battery includes a housing, an anode and a cathode within the housing, and a current collector at least partially disposed in the anode. The current collector includes an elongated body, in which a fuse including a fusing element is at least partially disposed. The method also includes increasing the temperature of the fusing element by at least about 100° C. (e.g., at least about 200° C., at least about 300° C., at least about 500° C., at least about 700° C., at least about 900° C., at least about 1000° C., at least about 1100° C., at least about 1300° C., at least about 1500° C., at least about 1700° C., at least about 1900° C.) while the temperature of the housing increases by at most about 80° C. (e.g., at most about 70° C., at most about 50° C., at most about 30° C., at most about 10° C., at most about 5° C.).

In an additional aspect, the invention features a method including increasing a temperature of a fusing element in a battery by at least about 100° C. (e.g., at least about 200° C., at least about 300° C., at least about 500° C., at least about 700° C., at least about 900° C., at least about 1000° C., at least about 1100° C., at least about 1300° C., at least about 1500° C., at least about 1700° C., at least about 1900° C.). The battery includes a housing, an anode and a cathode within the housing, and a current collector at least partially disposed in the anode. The current collector includes an elongated body, in which a fuse including the fusing element is at least partially disposed. The temperature of the housing increases by at most about 80° C. (e.g., at most about 70° C., at most about 60° C., at most about 50° C., at most about 40° C., at most about 30° C., at most about 20° C., at most about 10° C., at most about 5° C.) when the temperature of the fusing element is increased by at least about 100° C.

Embodiments can include one or more of the following features.

The fuse can have a current rating of about four amperes.

The fusing element can include a metal (e.g., copper). In certain embodiments, the metal can be plated. For example, the fusing element can include silver-plated copper. In some embodiments, the fusing element can have a melting point of at least about 200° C. (e.g., at least about 300° C., at least about 400° C., at least about 500° C., at least about 600° C., at least about 800° C., at least about 1000° C., at least about 1100° C., at least about 1200° C., at least about 1400° C., at least about 1600° C., at least about 1800° C., at least about 1900° C.), and/or at most about 2000° C. (e.g., at most about 1900° C., at most about 1800° C., at most about 1600° C., at most about 1400° C., at most about 1200° C., at most about 1100° C., at most about 1000° C., at most about 800° C., at most about 600° C., at most about 500° C., at most about 400° C., at most about 300° C.). For example, the fusing element can have a melting point of about 800° C.

In certain embodiments, the fusing element can have a resistance of at most about 50 milliohms (e.g., at most about 40 milliohms, at most about 30 milliohms, at most about 25 milliohms, at most about 18 milliohms, at most about 15 milliohms, at most about 10 milliohms, at most about five milliohms), and/or at least about one milliohm (e.g., at least about five milliohms, at least about 10 milliohms, at least about 15 milliohms, at least about 18 milliohms, at least about 25 milliohms, at least about 30 milliohms, at least about 40 milliohms).

The fusing element can have a width or diameter of at least 0.001 millimeter (e.g., at least about 0.01 millimeter, at least about 0.02 millimeter, at least about 0.03 millimeter, at least about 0.04 millimeter, at least about 0.05 millimeter, at least about 0.1 millimeter, at least about 0.2 millimeter, at least about 0.3 millimeter, at least about 0.4 millimeter, at least about 0.5 millimeter, at least about 0.7 millimeter, at least about 0.9 millimeter, at least about one millimeter, at least about 1.2 millimeters, at least about 1.4 millimeters), and/or at most about 1.5 millimeters (e.g., at most about 1.4 millimeters, at most about 1.2 millimeters, at most about one millimeter, at most about 0.9 millimeter, at most about 0.7 millimeter, at most about 0.5 millimeter, at most about 0.4 millimeter, at most about 0.3 millimeter, at most about 0.2 millimeter, at most about 0.1 millimeter, at most about 0.05 millimeter, at most about 0.04 millimeter, at most about 0.03 millimeter, at most about 0.02 millimeter, at most about 0.01 millimeter). In some embodiments (e.g., in some embodiments in which the fusing element includes copper), the fusing element can have a width or diameter of about 0.04 millimeter.

The fusing element can have a length of at least about 0.5 millimeter (e.g., at least about 0.7 millimeter, at least about 0.9 millimeter, at least about one millimeter, at least about two millimeters, at least about three millimeters, at least about four millimeters, at least about five millimeters, at least about 10 millimeters, at least about 15 millimeters, at least about 20 millimeters, at least about 25 millimeters), and/or at most about 30 millimeters (e.g., at most about 25 millimeters, at most about 20 millimeters, at most about 15 millimeters, at most about 10 millimeters, at most about five millimeters, at most about four millimeters, at most about three millimeters, at most about two millimeters, at most about one millimeter, at most about 0.9 millimeter, at most about 0.7 millimeter). In certain embodiments (e.g., in certain embodiments in which the fusing element includes copper), the fusing element can have a length of about two millimeters.

The current collector can include an elongated body. In certain embodiments, the fuse can be at least partially disposed in the elongated body. The current collector can include a metal (e.g., copper) or a metal alloy (e.g., brass).

The battery can include a sleeve. The sleeve can include (e.g., can be formed of) one or more insulating materials, such as one or more ceramics, glasses, and/or plastics. In certain embodiments, the sleeve can include one or more epoxies. In certain embodiments, the sleeve can include a heat-shrinkable material. The sleeve can be supported by the current collector. In some embodiments, the sleeve can contact the current collector.

The fuse can include a matrix within which the fusing element is at least partially disposed. The matrix can include (e.g., can be formed of) one or more insulating materials, such as one or more ceramics, glasses, and/or plastics. In some embodiments, the fusing element can be at least partially embedded in the matrix. In certain embodiments, the matrix can be integrally formed with the sleeve.

The battery can be a primary battery or a secondary battery. In some embodiments, the battery can have a cylindrical housing. In certain embodiments, the battery can include an alkaline electrolyte.

In some embodiments, the cathode can include a nickel oxyhydroxide.

The method can include melting the fusing element. In certain embodiments, melting the fusing element can include flowing a current of at least about five amperes and/or at most about 20 amperes (e.g., at most about 16 amperes) through the fusing element for more than about 10 seconds and/or less than about 60 seconds. In some embodiments, the fusing element can melt at a current of at least about five amperes (e.g., at least about seven amperes, at least about nine amperes, at least about 10 amperes, at least about 12 amperes, at least about 14 amperes, at least about 16 amperes, at least about 18 amperes), and/or at most about 20 amperes (e.g., at most about 18 amperes, at most about 16 amperes, at most about 14 amperes, at most about 12 amperes, at most about 10 amperes, at most about nine amperes, at most about seven amperes). In certain embodiments, the fusing element can melt after a current of about 10 amperes has been flowing through the fusing element for at least about 0.04 second and/or at most about one second.

Embodiments can include one or more of the following advantages.

In some embodiments, a fuse can deactivate a battery even though certain parts of the battery (e.g., the housing) are at a relatively low temperature (e.g., about 25° C.). For example, during operation of the battery, the temperature of the fuse (or specific components of the fuse) may become relatively high (e.g., at least about 400° C., at least about 600° C., at least about 800° C., at least about 1200° C., at least about 1600° C., at least about 1800° C.), while the temperature of the housing of the battery is relatively low (e.g., about 25° C.). The relatively high temperature of the fuse (or specific components of the fuse) can cause a fusing element in the fuse to melt, even though the housing of the battery is at a relatively low temperature. When the fusing element melts, it can slow or stop current flow through the battery, and can thereby deactivate the battery.

In certain embodiments, a battery can include a fuse that provides relatively little resistance, even when the temperature of a fusing element in the fuse is somewhat elevated (e.g., when the temperature of the fusing element is at least about 30° C., at least about 50° C., or at least about 80° C.). For example, the fuse can include a fusing element having a resistance of at most about 50 milliohms (e.g., at most about 25 milliohms, at most about 18 milliohms, at most about 15 milliohms, at most about 10 milliohms, at most about five milliohms). A fuse that provides relatively little resistance can allow a battery that includes the fuse to continue to operate, even when the temperature of the fusing element becomes somewhat elevated as a result of temporary high-current draw situations that can occur during normal battery use.

In some embodiments, a battery that includes a fuse can be relatively safe. For example, if the battery is short-circuited, a fusing element in the fuse can melt, thereby limiting or preventing current flow through the battery, and limiting the likelihood of the battery overheating and/or exploding. In certain embodiments, a fuse can deactivate a battery relatively quickly (e.g., once a fusing element in the fuse has reached a threshold elevated temperature). This can limit the likelihood of the battery harming a user once abnormal and/or abusive battery operating conditions have occurred.

In some embodiments, a fuse can be relatively easily incorporated into a battery, and/or can be a relatively inexpensive addition to a battery. In certain embodiments, a fuse can occupy relatively little space in a battery, and can thereby provide room in the battery for other components, such as electrode active materials.

In some embodiments, a battery that includes a fuse (e.g., a battery having a nickel oxyhydroxide cathode) can be used for high-rate applications (e.g., to power a digital camera and/or a cellular phone), while also being relatively safe.

Other aspects, features, and advantages of the invention are in the drawings, description, and claims.

### DESCRIPTION OF DRAWINGS

FIG. 1 is a cross-sectional view of an embodiment of a battery.

FIG. 2 is an enlarged view of a component of the battery of FIG. 1.

FIG. 3 is an enlarged view of a component of the battery of FIG. 1.

### DETAILED DESCRIPTION

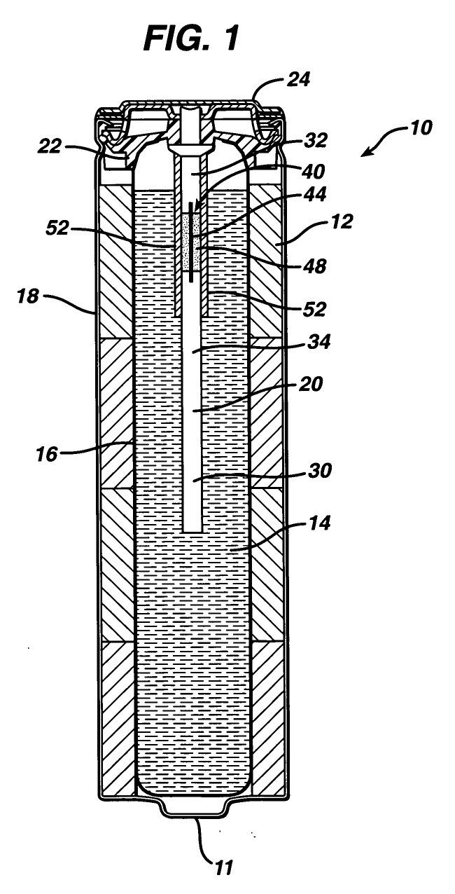

Referring to FIG. 1, a battery or electrochemical cell 10 has a cylindrical housing 18 containing a cathode 12, an anode 14, a separator 16 between cathode 12 and anode 14, and a current collector 20. Cathode 12 includes a cathode active material, and anode 14 includes an anode active material. Battery 10 also includes a seal 22 and a metal top cap 24, which, along with current collector 20, serve as the negative terminal for the battery. Cathode 12 is in contact with housing 18, and the positive terminal 11 of battery 10 is at the end of the battery opposite from the negative terminal. An electrolyte is dispersed throughout battery 10. A battery such as battery 10 can be used, for example, in high-rate applications, such as powering digital cameras and/or cellular phones.

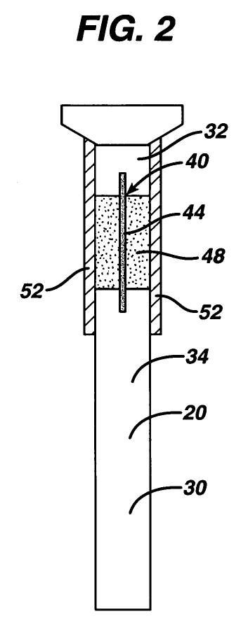

FIG. 2 shows an enlarged view of current collector 20. Current collector 20 has an elongated body 30 including a first portion 32 and a second portion 34, and a fuse 40 disposed between first portion 32 and second portion 34. Fuse 40 includes a fusing element 44 that is partially embedded in a matrix 48. As shown in FIGS. 1 and 2, fusing element 44 extends through matrix 48, into both first portion 32 and second portion 34 of elongated body 30. A sleeve 52 is wrapped around a portion of current collector 20, and contacts first portion 32, second portion 34, and fuse 40.

Fuse 40 can slow or stop current flow through battery 10 when, for example, an operator has short-circuited battery 10. When battery 10 is short-circuited, the current flow through battery 10 can become relatively high. Under conditions of high current flow, the current flowing through fusing element 44 can cause fusing element 44 (and, in some embodiments, the environment immediately surrounding fusing element 44, such as the other components of fuse 40) to increase in temperature. When fusing element 44 reaches a certain elevated temperature, fusing element 44 can melt, thereby slowing or stopping current flow through fusing element 44. As a result, current flow through battery 10 can slow or stop. By slowing or stopping current flow through battery 10, fuse 40 can limit the likelihood of battery 10 overheating, exploding, and/or causing a fire. In some embodiments, a fuse (e.g., fuse 40) can be incorporated into a battery (e.g., battery 10) without significantly adversely affecting the electrochemical performance of the battery.

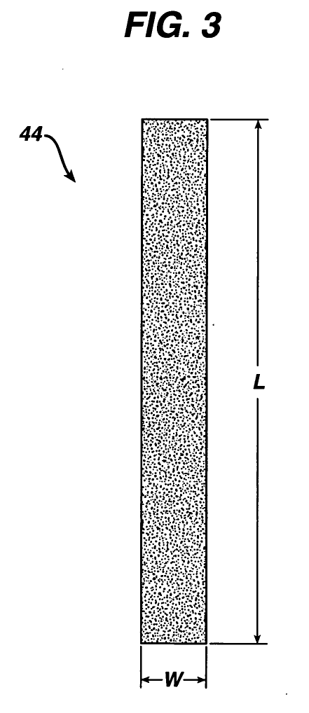

As shown in FIG. 3, fusing element 44 of fuse 40 has a length L and a width or diameter W. Length L and/or width or diameter W can be selected to increase the likelihood that fusing element 44 will melt once the current flow through battery 10 has reached a threshold level. In some embodiments, length L and/or width or diameter W can be selected so that during periods of high current flow, the temperature of fusing element 44 (and, in some embodiments, the temperature of the immediate environment of fusing element 44) increases significantly, while the temperature of other regions of battery 10 (e.g., housing 18) does not increase significantly. Thus, the ability of fuse 40 to interrupt current flow through battery 10 may not depend upon the overall temperature of battery 10. As a result, in certain embodiments, fuse 40 can slow or stop current flow through battery 10 relatively quickly, without depending upon an increase in the overall temperature of battery 10.

In some embodiments, length L can be at least about 0.5 millimeter (e.g., at least about 0.7 millimeter, at least about 0.9 millimeter, at least about one millimeter, at least about two millimeters, at least about three millimeters, at least about four millimeters, at least about five millimeters, at least about 10 millimeters, at least about 15 millimeters, at least about 20 millimeters, at least about 25 millimeters), and/or at most about 30 millimeters (e.g., at most about 25 millimeters, at most about 20 millimeters, at most about 15 millimeters, at most about 10 millimeters, at most about five millimeters, at most about four millimeters, at most about three millimeters, at most about two millimeters, at most about one millimeter, at most about 0.9 millimeter, at most about 0.7 millimeter).

In certain embodiments, width or diameter W can be at least 0.001 millimeter (e.g., at least about 0.01 millimeter, at least about 0.02 millimeter, at least about 0.03 millimeter, at least about 0.04 millimeter, at least about 0.05 millimeter, at least about 0.1 millimeter, at least about 0.2 millimeter, at least about 0.3 millimeter, at least about 0.4 millimeter, at least about 0.5 millimeter, at least about 0.7 millimeter, at least about 0.9 millimeter, at least about one millimeter, at least about 1.2 millimeters, at least about 1.4 millimeters), and/or at most about 1.5 millimeters (e.g., at most about 1.4 millimeters, at most about 1.2 millimeters, at most about one millimeter, at most about 0.9 millimeter, at most about 0.7 millimeter, at most about 0.5 millimeter, at most about 0.4 millimeter, at most about 0.3 millimeter, at most about 0.2 millimeter, at most about 0.1 millimeter, at most about 0.05 millimeter, at most about 0.04 millimeter, at most about 0.03 millimeter, at most about 0.02 millimeter, at most about 0.01 millimeter).

In some embodiments (e.g., in some embodiments in which fusing element 44 includes copper), length L can be about two millimeters, and/or width or diameter W can be about 0.04 millimeter.

Fusing element 44 can be formed of one material or more than one material. The materials can be selected based on, for example, the rate at which they heat up, their resistivity, their melting point, and/or their mechanical strength. In certain embodiments, fusing element 44 can include one or more metals (e.g., copper, gold, nickel) and/or metal alloys (e.g., nickel alloys). In some embodiments, fusing element 44 can include a plated metal, such as a silver-plated metal. For example, fusing element 44 can include silver-plated copper. In certain embodiments, fusing element 44 can include chrome. In some embodiments, fusing element 44 can include one or more materials that are selected to result in little or no hydrogen gas evolution by fusing element 44 during operation of battery 10.

In certain embodiments, fusing element 44 can include one or more materials with a relatively high melting point. This can, for example, allow battery 10 to operate under standard operating conditions (e.g., about 25° C., about 30° C.) without being deactivated by fuse 40. In some embodiments, fusing element 44 can include one or more materials having a melting point of at least about 200° C. (e.g., at least about 300° C., at least about 400° C., at least about 500° C., at least about 600° C., at least about 800° C., at least about 1000° C., at least about 1100° C., at least about 1200° C., at least about 1400° C., at least about 1600° C., at least about 1800° C., at least about 1900° C.), and/or at most about 2000° C. (e.g., at most about 1900° C., at most about 1800° C., at most about 1600° C., at most about 1400° C., at most about 1200° C., at most about 1100° C., at most about 1000° C., at most about 800° C., at most about 600° C., at most about 500° C., at most about 400° C., at most about 300° C.). For example, fusing element 44 can include one or more materials having a melting point of from about 500° C. to about 1200° C. (e.g., from about 800° C. to about 1100° C., about 800° C., about 1064° C., about 1083° C.). In some embodiments, fusing element 44 can include one or more materials having a melting point of about 1900° C.

In certain embodiments, fusing element 44 can have a resistance of at most about 50 milliohms (e.g., at most about 25 milliohms, at most about 18 milliohms, at most about 15 milliohms, at most about 10 milliohms, at most about five milliohms).

In some embodiments, fusing element 44 can be adapted to melt at a relatively high temperature while housing 18 is at a relatively low temperature. For example, in certain embodiments, fusing element 44 can be adapted to melt at a temperature of at least about 200° C. (e.g., at least about 300° C., at least about 400° C., at least about 500° C., at least about 600° C., at least about 800° C., at least about 1000° C., at least about 1100° C., at least about 1200° C., at least about 1400° C., at least about 1600° C., at least about 1800° C., at least about 1900° C.), while housing 18 is at a temperature of at most about 90° C. (e.g., at most about 87° C., at most about 80° C., at most about 79° C., at most about 70° C., at most about 60° C., at most about 50° C., at most about 40° C., at most about 30° C., at most about 25° C.). In some embodiments, fusing element 44 can melt while housing 18 is at a temperature of from about 20° C. to about 25° C. (e.g., from about 23° C. to about 24° C.).

In some embodiments, fusing element 44 can be adapted to melt when the current flowing through fusing element 44 is at least about five amperes (e.g., at least about six amperes, at least about seven amperes, at least about eight amperes, at least about nine amperes, at least about 10 amperes, at least about 11 amperes, at least about 12 amperes, at least about 13 amperes, at least about 14 amperes, at least about 15 amperes, at least about 16 amperes, at least about 17 amperes, at least about 18 amperes, at least about 19 amperes), and/or at most about 20 amperes (e.g., at most about 19 amperes, at most about 18 amperes, at most about 17 amperes, at most about 16 amperes, at most about 15 amperes, at most about 14 amperes, at most about 13 amperes, at most about 12 amperes, at most about 11 amperes, at most about 10 amperes, at most about nine amperes, at most about eight amperes, at most about seven amperes, at most about six amperes). For example, fusing element 44 may be adapted to melt when the current flowing through fusing element 44 is about five amperes, about six amperes, about seven amperes, about eight amperes, about nine amperes, about 10 amperes, about 11 amperes, about 12 amperes, about 13 amperes, about 14 amperes, about 15 amperes, about 16 amperes, about 17 amperes, about 18 amperes, about 19 amperes, or about 20 amperes.

In some embodiments, fusing element 44 can be melted by flowing a current of at least about five amperes and/or at most about 20 amperes (e.g., about 13 amperes) through fusing element 44.

In some embodiments, fusing element 44 can be adapted to melt after at least 0.005 second (e.g., at least about 0.01 second, at least about 0.04 second, at least about 0.1 second, at least about 0.5 second, at least about one second, at least about two seconds, at least about three seconds, at least about four seconds, at least about five seconds, at least about 10 seconds, at least about 15 seconds, at least about 20 seconds, at least about 40 seconds) and/or at most about 60 seconds (e.g., at most about 40 seconds, at most about 20 seconds, at most about 15 seconds, at most about 10 seconds, at most about five seconds, at most about four seconds, at most about three seconds, at most about two seconds, at most about one second, at most about 0.5 second, at most about 0.1 second, at most about 0.04 second, at most about 0.01 second) of current flowing through fusing element 44.

In certain embodiments, fusing element 44 can melt after at least 0.005 second (e.g., at least about 0.01 second, at least about 0.04 second, at least about 0.1 second, at least about 0.5 second, at least about one second, at least about two seconds, at least about three seconds, at least about four seconds, at least about five seconds, at least about 10 seconds, at least about 15 seconds, at least about 20 seconds, at least about 40 seconds), and/or at most about 60 seconds (e.g., at most about 40 seconds, at most about 20 seconds, at most about 15 seconds, at most about 10 seconds, at most about five seconds, at most about four seconds, at most about three seconds, at most about two seconds, at most about one second, at most about 0.5 second, at most about 0.1 second, at most about 0.04 second, at most about 0.01 second), of a 10-ampere current flowing through fusing element 44.

In certain embodiments, fusing element 44 can be melted by flowing a current through fusing element 44 for more than about 10 seconds (e.g., at least about 15 seconds, at least about 20 seconds, at least about 30 seconds, at least about 40 seconds, at least about 50 seconds), and/or less than about 60 seconds (e.g., at most about 50 seconds, at most about 40 seconds, at most about 30 seconds, at most about 20 seconds, at most about 15 seconds).

In some embodiments, fusing element 44 can be melted by flowing a current of about 13 amperes through fusing element 44 for about 14 milliseconds or about 40 milliseconds.

In some embodiments, during operation of battery 10, the temperature of fusing element 44 can increase by at least about 100° C. (e.g., at least about 200° C., at least about 300° C., at least about 500° C., at least about 700° C., at least about 900° C., at least about 1000° C., at least about 1100° C., at least about 1300° C., at least about 1500° C., at least about 1700° C., at least about 1900° C.), and/or at most about 2000° C. (e.g., at most about 1900° C., at most about 1700° C., at most about 1500° C., at most about 1300° C., at most about 1100° C., at most about 900° C., at most about 700° C., at most about 500° C., at most about 400° C., at most about 300° C., at most about 200° C.). In certain embodiments, while the temperature of fusing element 44 is increasing, the temperature of housing 18 can increase by at most about 80° C. (e.g., at most about 70° C., at most about 60° C., at most about 50° C., at most about 40° C., at most about 30° C., at most about 20° C., at most about 10° C., at most about 5° C.). In some embodiments, the temperature of fusing element 44 can increase, while the temperature of housing 18 does not increase at all.

In certain embodiments, one or more of the aspects of fusing element 44 (e.g., length L, width or diameter W, the materials out of which fusing element 44 is formed) can be selected so that battery 10 is not deactivated during transient high current situations that can be encountered during normal product usage. Transient high current situations can occur, for example, during battery insertion and/or during extreme conditions of device usage. For example, when a motor is used in relatively cold temperatures, the motor may draw a relatively large current when starting up, and may thereafter draw a smaller current.

The current rating of fuse 40 can be selected based on the desired current draw during use of battery 10. For example, in some embodiments, the current rating of fuse 40 can be selected to be higher than the desired current drain during use of battery 10. Generally, as the current rating of a fuse decreases, the resistance of the fuse can increase. In certain embodiments, fuse 40 can have a current rating of, for example, about four amperes.

An example of a commercially available fuse is the model 251 4.0 amp pico fuse from Littelfuse® (Des Plaines, Ill.).

As described above, in addition to including fusing element 44, fuse 40 also includes matrix 48, which can provide structural support for fusing element 44. Matrix 48 can include one or more materials that are selected to provide matrix 48 with mechanical strength. In some embodiments, matrix 48 can include (e.g., can be formed of) one or more insulating materials. As used herein, an insulating material can be a material having a resistivity of at least 1×10⁵ ohm-cm. Examples of insulating materials include plastics, glasses, ceramics, and combinations thereof. In some embodiments, matrix 48 can include one or more epoxies. In certain embodiments, matrix 48 can include (e.g., can be formed of) one or more materials that are covered with a chemically inert coating. In some embodiments, matrix 48 can include (e.g., can be formed of) one or more of the same materials as sleeve 52.

In certain embodiments, matrix 48 can be attached to first portion 32 and/or second portion 34. Matrix 48 can be attached to first portion 32 and/or second portion 34 using, for example, an adhesive.

As shown in FIGS. 1 and 2, sleeve 52 is wrapped around fuse 40 and a portion of elongated body 30 of current collector 20, and is immersed in anode 14. Sleeve 52, which includes (e.g., is formed of) one or more insulating materials, can limit the likelihood of a current circumventing fusing element 44 by shorting across fusing element 44. Examples of insulating materials include plastics, glasses, ceramics, and combinations thereof. In some embodiments, sleeve 52 can include one or more epoxies. In certain embodiments, sleeve 52 can include (e.g., can be formed of) one or more materials that are covered with a chemically inert coating. In some embodiments, sleeve 52 can include one or more heat-shrinkable materials. The heat-shrinkable materials can allow sleeve 52 to be heat-shrunk around elongated body 30 of current collector 20.

In certain embodiments, sleeve 52 can be attached to first portion 32 and/or second portion 34 of elongated body 30, and/or can be attached to matrix 48. Sleeve 52 can be attached to first portion 32, second portion 34, and/or matrix 48 using, for example, an adhesive. In certain embodiments, sleeve 52 can be integrally formed with matrix 48.

First portion 32 and/or second portion 34 of elongated body 30 of current collector 20 can include (e.g., can be formed of) the same materials or different materials. In some embodiments, first portion 32 and/or second portion 34 can include one or more metals and/or metal alloys, such as copper or brass (e.g., an alloy of 60% zinc and 40% copper). The metals and/or metal alloys can be plated (e.g., tin-plated). In certain embodiments, first portion 32 and/or second portion 34 can include tin-plated copper. In some embodiments, the metals and/or metal alloys can be selected to limit the likelihood of accelerating self-discharge of anode 14, and/or to limit the likelihood of adding significant resistance to battery 10. In certain embodiments, first portion 32 and/or second portion 34 can include one or more materials that are selected to be compatible with a zinc anode slurry.

Fusing element 44 can be attached to first portion 32 and/or second portion 34 of elongated body 30 of current collector 20 by, for example, soldering.

Cathode 12 includes at least one (e.g., two, three) cathode active material. In some embodiments, cathode 12 can further include at least one conductive aid and/or at least one binder. The electrolyte also is dispersed through cathode 12. The weight percentages provided herein with respect to components of cathode 12 are determined after the electrolyte has been dispersed through cathode 12.

In some embodiments, the cathode active material can be a manganese oxide, such as manganese dioxide (MnO₂). The manganese dioxide can be electrolytically-synthesized MnO₂ (EMI), chemically-synthesized MnO₂ (CMD), or a blend of EMD and CMD. Distributors of manganese dioxides include Kerr-McGee Corp. (manufacturer of, e.g., Trona D and high-power EMD), Tosoh Corp., Delta Manganese, Delta EMD Ltd., Mitsui Chemicals, ERACHEM, and JMC. In certain embodiments, cathode 12 can include from about 80 percent to about 88 percent by weight (e.g., from about 82 percent to about 86 percent by weight) manganese dioxide (e.g., EMD).

Other examples of cathode active materials include copper oxides (e.g., cupric oxide (CuO), cuprous oxide (Cu₂O)); copper hydroxides (e.g., cupric hydroxide (Cu(OH)₂), cuprous hydroxide (Cu(OH))); cupric iodate (Cu(IO₃)₂); AgCuO₂; LiCuO₂; Cu(OH)(IO₃); Cu₂H(IO₆); copper-containing metal oxides or chalcogenides; copper halides (e.g., CUCl₂); and/or copper manganese oxides (e.g., Cu(MnO₄)₂). The copper oxides can be stoichiometric (e.g., CuO) or non-stoichiometric (e.g., CuOₓ, where 0.5≦x≦1.5). Another example of a cathode active material is Cu₆InO₈Cl.

Further examples of cathode active materials include cathode active materials that include nickel, such as a nickel oxyhydroxide (NiOOH). The nickel oxyhydroxide can include, for example, a beta-nickel oxyhydroxide, a cobalt oxyhydroxide-coated beta-nickel oxyhydroxide, a gamma-nickel oxyhydroxide, a cobalt oxyhydroxide-coated gamma-nickel oxyhydroxide, a solid solution of a beta-nickel oxyhydroxide and a gamma-nickel oxyhydroxide, or a cobalt oxyhydroxide-coated solid solution of a beta-nickel oxyhydroxide and a gamma-nickel oxyhydroxide.

Additional examples of cathode active materials include cathode active materials including a pentavalent bismuth-containing metal oxide.

In certain embodiments, cathode 12 can be porous. A porous cathode can include, for example, one or more of the above-described cathode active materials (e.g., EMD, NiOOH).

The conductive aid can increase the electronic conductivity of cathode 12. An example of a conductive aid is carbon particles. The carbon particles can be any of the conventional carbon particles used in cathodes. The carbon particles can be, for example, graphite particles. Graphite particles that are used in cathode 12 can be any of the graphite particles used in cathodes. The particles can be synthetic, non-synthetic, or a blend of synthetic and non-synthetic, and they can be expanded or non-expanded. In certain embodiments, the graphite particles are non-synthetic, non-expanded graphite particles. In such embodiments, the graphite particles can have an average particle size of less than about 20 microns (e.g., from about two microns to about 12 microns, from about five microns to about nine microns), as measured using a Sympatec HELIOS analyzer. Graphite particles can be obtained from, for example, Brazilian Nacional de Grafite (Itapecirica, MG Brazil (MP-0702X)) or Chuetsu Graphite Works, Ltd. (Chuetsu grades WH-20A and WH-20AF) of Japan. Cathode 12 may include for example, from about three percent to about nine percent (e.g., from about four percent to about seven percent) carbon particles by weight. In some embodiments, cathode 12 can include from about four percent to about nine percent (e.g., from about four percent to about 6.5 percent) graphite particles by weight.

Another example of a conductive aid is carbon fibers, such as those described in Luo et al., U.S. Pat. No. 6,858,349, and in Anglin, U.S. Patent Application Publication No. US 2002/0172867 A1, published on Nov. 21, 2002, and entitled “Battery Cathode”. In some embodiments, cathode 12 can include less than about two percent by weight (e.g., less than about 1.5 percent by weight, less than about one percent by weight, less than about 0.75 percent by weight, less than about 0.5 percent by weight), and/or more than about 0.1 percent by weight (e.g., more than about 0.2 percent by weight, more than about 0.3 percent by weight, more than about 0.4 percent by weight, more than about 0.45 percent by weight) carbon fibers.

In certain embodiments, cathode 12 can include from about one percent by weight to about 10 percent by weight of one or more total conductive aids.

A cathode can be made by coating a cathode material onto a current collector, and drying and then calendering the coated current collector. The cathode material can be prepared by mixing the cathode active material together with other components, such as a binder, solvent/water, and a carbon source. For example, a cathode active material such as MnO₂ may be combined with carbon (e.g., graphite, acetylene black), and mixed with small amount of water to form a cathode slurry. A current collector can then be coated with the cathode slurry to form the cathode.

Examples of binders include polyethylene powders, polyacrylamides, Portland cement and fluorocarbon resins, such as polyvinylidenefluoride (PVDF) and polytetrafluoroethylene (PTFE). An example of a polyethylene binder is sold under the trade name Coathylene HA-1681 (available from Hoechst). Cathode 12 may include, for example, up to about two percent binder by weight (e.g., up to about one percent binder by weight). In certain embodiments, cathode 12 can include from about 0.1 percent to about two percent (e.g., from about 0.1 percent to about one percent) binder by weight.

Cathode 12 can include other additives. Additives are disclosed, for example, in Mieczkowska et al., U.S. Pat. No. 5,342,712. In some embodiments, cathode 12 can include titanium dioxide (TiO₂). In certain embodiments, cathode 12 can include from about 0.1 percent to about two percent (e.g., from about 0.2 percent to about two percent) TiO₂ by weight.

Cathodes (e.g., cathode active materials) are described, for example, in Durkot et al., U.S. Patent Application Publication No. US 2004/0237293 A1, published on Dec. 2, 2004, and entitled “Alkaline Cell With Flat Housing and Nickel Oxyhydroxide Cathode”; Durkot et al., U.S. Patent Application Publication No. US 2004/0197656 A1, published on Oct. 7, 2004, and entitled “Alkaline Battery Including Nickel Oxyhydroxide Cathode and Zinc Anode”; Bowden et al., U.S. Patent Application Publication No. US 2004/0076881 A1, published on Apr. 22, 2004, and entitled “Method of Making a Battery”; Eylem et al., U.S. Patent Application Publication No. US 2005/0136328 A1, published on Jun. 23, 2005, and entitled “Battery Cathode”; Christian et al., U.S. Patent Application Publication No. US 2004/0043292 A1, published on Mar. 4, 2004, and entitled “Alkaline Battery Including Nickel Oxyhydroxide Cathode and Zinc Anode”; Christian et al., U.S. Patent Application Publication No. US 2004/0202931 A1, published on Oct. 14, 2004, and entitled “Preparation of Nickel Oxyhydroxide”; Eylem et al., U.S. Patent Application Publication No. US 2005/0058903 A1, published on Mar. 17, 2005, and entitled “Primary Alkaline Battery Containing Bismuth Metal Oxide”; Wang et al., U.S. Patent Application Publication No. US 2005/0058902 A1, published on Mar. 17, 2005, and entitled “Primary Alkaline Battery Containing Bismuth Metal Oxide”; and Kelsey et al., U.S. Pat. No. 6,207,322.

The electrolyte that is dispersed through cathode 12 (and/or the electrolyte used in the rest of battery 10) can be any of the electrolytes used in batteries. In some embodiments, cathode 12 can include from about five percent to about eight percent (e.g., from about six percent to about seven percent) electrolyte by weight. The electrolyte can be aqueous or non-aqueous. An aqueous electrolyte can be an alkaline solution, such as an aqueous hydroxide solution (e.g., LiOH, NaOH, KOH), or a mixture of hydroxide solutions (e.g., NaOH/KOH). For example, the aqueous hydroxide solution can include from about 33 percent by weight to about 40 percent by weight of the hydroxide material, such as about 9N KOH (about 37 percent by weight KOH). In some embodiments, the electrolyte can also include up to about four percent by weight (e.g., about two percent by weight) of zinc oxide.

The electrolyte can include other additives. As an example, the electrolyte can include a soluble material (e.g., an aluminum material) that reduces (e.g., suppresses) the solubility of the cathode active material in the electrolyte. In certain embodiments, the electrolyte can include one or more of the following: aluminum hydroxide, aluminum oxide, alkali metal aluminates, aluminum metal, alkali metal halides, alkali metal carbonates, or mixtures thereof. Electrolyte additives are described, for example, in Eylem et al., U.S. Patent Application Publication No. US 2004/0175613 A1, published on Sep. 9, 2004, and entitled “Battery”.

Housing 18 can be any housing commonly used in batteries. As shown, housing 18 is a cylindrical housing. However, housings with other shapes, such as prismatic housings, can be used. In some embodiments, housing 18 can be made of a metal or a metal alloy, such as nickel, nickel-plated steel (e.g., nickel-plated cold-rolled steel), stainless steel, aluminum-clad stainless steel, aluminum, or an aluminum alloy. In certain embodiments, housing 18 can be made of a plastic, such as polyvinyl chloride, polypropylene, a polysulfone, acrylonitrile butadiene styrene (ABS), or a polyamide.

In some embodiments, housing 18 can include an inner metal wall and an outer electrically non-conductive material such as heat-shrinkable plastic. Optionally, a layer of conductive material can be disposed between the inner wall and cathode 12. The layer may be disposed along the inner surface of the inner wall, along the circumference of cathode 12, or both. This conductive layer can be formed, for example, of a carbonaceous material (e.g., graphite). Such materials include, for example, LB1000 (Timcal), Eccocoat 257 (W.R. Grace & Co.), Electrodag 109 (Acheson Colloids Co.), Electrodag 112 (Acheson), Varniphite 5000 (Nippon), and EB0005 (Acheson). Methods of applying the conductive layer are disclosed, for example, in Canadian Patent No. 1,263,697.

Anode 14 can be formed of any of the zinc materials used in battery anodes. For example, anode 14 can be a zinc gel that includes zinc metal particles, a gelling agent, and minor amounts of additives, such as gassing inhibitor. In addition, a portion of the electrolyte is dispersed throughout the anode.

The zinc particles can be any of the zinc particles (e.g., zinc fines) used in gel anodes. Examples of zinc particles include those described in Durkot et al., U.S. Pat. No. 6,284,410, and in Durkot et al., U.S. Pat. No. 6,521,378. In certain embodiments, anode 14 can include spherical zinc particles. Spherical zinc particles are described, for example, in Costanzo et al., U.S. Patent Application Publication No. US 2004/0258995 A1, published on Dec. 23, 2004, and entitled “Anode for Battery”. The zinc particles can be a zinc alloy (e.g., containing a few hundred parts per million of indium and bismuth). Anode 14 may include, for example, from about 40 percent to about 90 percent (e.g., from about 67 percent to about 80 percent) zinc particles by weight.

Examples of gelling agents include polyacrylic acids, grafted starch materials, salts of polyacrylic acids, polyacrylates, carboxymethylcellulose or combinations thereof. Examples of polyacrylic acids include Carbopol 940 and 934 (available from Noveon Inc.) and Polygel 4P (available from 3V). An example of a grafted starch material is Waterlock A221 (available from Grain Processing Corporation, Muscatine, Iowa). An example of a salt of a polyacrylic acid is Alcosorb G1 (available from Ciba Specialties). Anode 14 may include, for example, from about 0.1 percent to about one percent gelling agent by weight.

Gassing inhibitors can be inorganic materials, such as bismuth, tin, lead and indium. Alternatively, gassing inhibitors can be organic compounds, such as phosphate esters, ionic surfactants or nonionic surfactants. Examples of ionic surfactants are disclosed, for example, in Chalilpoyil et al., U.S. Pat. No. 4,777,100.

Separator 16 can be formed of any of the standard separator materials used in electrochemical cells (e.g., alkaline cells). For example, separator 16 can be formed of polypropylene (e.g., non-woven polypropylene or microporous polypropylene), polyethylene, polytetrafluoroethylene, a polyamide (e.g., a nylon), a polysulfone, a polyvinyl chloride, or combinations thereof. In some embodiments, separator 16 can include a layer of cellophane combined with a layer of a non-woven material. The non-woven material can include, for example, polyvinyl alcohol and/or rayon.

Seal 22 can be made of, for example, a polymer (e.g., nylon).

Cap 24 can be made of, for example, a metal or a metal alloy, such as aluminum, nickel, titanium, or steel.

In some embodiments, battery 10 can include a hydrogen recombination catalyst to lower the amount of hydrogen gas that may be generated in the cell by anode 14 (e.g., when anode 14 includes zinc). Hydrogen recombination catalysts are described, for example, in Davis et al., U.S. Pat. No. 6,500,576, and in Kozawa, U.S. Pat. No. 3,893,870. Alternatively or additionally, battery 10 can be constructed to include pressure-activated valves or vents, such as those described in Tomantschger et al., U.S. Pat. No. 5,300,371.

Weight percentages of battery components provided herein are determined after the electrolyte solution has been dispersed in the battery.

Battery 10 can be a primary electrochemical cell or a secondary electrochemical cell. Primary cells are meant to be discharged (e.g., to exhaustion) only once, and then discarded. Primary cells are not intended to be recharged. Primary cells are described, for example, in David Linden, Handbook of Batteries (McGraw-Hill, 2d ed. 1995). Secondary electrochemical cells can be recharged for many times (e.g., more than fifty times, more than a hundred times, or more). In some embodiments, secondary cells can include relatively robust separators, such as separators that have many layers and/or separators that are relatively thick. Secondary cells can also be designed to accommodate for changes, such as swelling, that can occur in the cells. Secondary cells are described, for example, in Falk & Salkind, “Alkaline Storage Batteries”, John Wiley & Sons, Inc. 1969, and in Virloy et al., U.S. Pat. No. 345,124.

Battery 10 can be of any of a number of different voltages (e.g., 1.5 V, 3.0 V, 4.0 V), and/or can be, for example, a AA, AAA, AAAA, C, or D battery. While battery 10 is cylindrical, in some embodiments, a battery can be non-cylindrical. For example, a battery can be a coin cell, a button cell, a wafer cell, or a racetrack-shaped cell. In some embodiments, a battery can be prismatic. In certain embodiments, a battery can have a rigid laminar cell configuration or a flexible pouch, envelope or bag cell configuration. In some embodiments, a battery can have a spirally wound configuration, or a flat plate configuration. Batteries are described, for example, in Bedder et al., U.S. Pat. No. 4,622,277; McVeigh, Jr. et al., U.S. Pat. No. 4,707,421; Batson et al., U.S. Pat. No. 6,001,504; Berkowitz et al., U.S. patent application Ser. No. 10/675,512, filed on Sep. 30, 2003, and entitled “Batteries”; Totir et al., U.S. patent application Ser. No. 10/800,905, filed on Mar. 15, 2004, and entitled “Non-Aqueous Electrochemical Cells”; Durkot et al., U.S. Patent Application Publication No. US 2004/0237293 A1, published on Dec. 2, 2004, and entitled “Alkaline Cell With Flat Housing and Nickel Oxyhydroxide Cathode”; and Berkowitz et al., U.S. Patent Application Publication No. US 2005/0112467 A1, published on May 26, 2005, and entitled “Battery Including Aluminum Component”.

A cell (e.g., a cylindrical cell) can be prepared by, for example, rolling an anode, separator, and cathode together, and placing them in a housing. The housing (containing the anode, the cathode, and the separator) can then be filled with the electrolytic solution and subsequently hermetically sealed with, for example, a cap and annular insulating gasket.

In some embodiments, a cell (e.g., a cylindrical cell) can be prepared by spirally winding an anode, a cathode, and a separator together, with a portion of the cathode current collector extending axially from one end of the roll. The portion of the current collector that extends from the roll can be free of cathode active material. To connect the current collector with an external contact, the exposed end of the current collector can be welded to a metal tab, which is in electric contact with an external battery contact. The grid can be rolled in the machine direction, the pulled direction, perpendicular to the machine direction, or perpendicular to the pulled direction. The tab can be welded to the grid to minimize the conductivity of grid and tab assembly. Alternatively, the exposed end of the current collector can be in mechanical contact (e.g., not welded) with a positive lead which is in electric contact with an external battery contact. A cell having a mechanical contact and not having a welded contact can require fewer parts and steps to manufacture than a cell with a welded contact. In certain embodiments, the effectiveness of the mechanical contact can be enhanced by bending the exposed grid towards the center of the roll to create a dome or crown, with the highest point of the crown over the axis of the roll, corresponding to the center of a cylindrical cell. In the crown configuration, the grid can have a denser arrangement of strands than in the non-shaped form. A crown can be orderly folded and the dimensions of a crown can be precisely controlled.

Methods for assembling electrochemical cells are described, for example, in Moses, U.S. Pat. No. 4,279,972; Moses et al., U.S. Pat. No. 4,401,735; and Kearney et al., U.S. Pat. No. 4,526,846.

While certain embodiments have been described, other embodiments are possible.

As an example, while a battery including a fuse that is disposed in an anode current collector has been described, in certain embodiments, a battery can alternatively or additionally include a fuse that is disposed in a cathode current collector.

As another example, while a battery including a fuse that is disposed in a current collector has been described, in some embodiments, a battery can include a fuse in one or more other locations. A fuse can be located, for example, in any region of a battery in which electrons are collected from the battery active material during discharge of the battery. For example, in some embodiments, a fuse can be located between a node of a battery (e.g., the positive terminal of the battery) and the contact between the node and a device being powered by the battery. In certain embodiments, a terminal of the battery (e.g., the positive terminal) can include a fuse. For example, a terminal of a battery can be formed of a fuse. In some embodiments, a fuse in a battery can be in contact with one of the electrodes of the battery (e.g., the anode), while not being in contact with another electrode of the battery. In certain embodiments, multiple (e.g., two, three, four, five, 10) electrochemical cells can be used together to form a battery pack. One or more fuses can be located between electrochemical cells in the battery pack.

As a further example, while a battery including a sleeve has been described, in certain embodiments, a battery may not include a sleeve. In some embodiments, a battery can include one or more insulating materials that are not in the form of a sleeve. For example, a battery can include one or more strips of insulating materials that are attached to a current collector of the battery.

As another example, in some embodiments, a battery can include multiple (e.g., two, three, four, five) fuses.

As an additional example, in certain embodiments, a battery can include at least one thermally activated current interrupt mechanism, such as one of the thermally activated current interrupt mechanisms disclosed in Vu et al., U.S. Pat. No. 5,750,277.

As another example, in certain embodiments, one or more miniature chip-type fuses can be used in a battery. In some embodiments, a miniature chip-type fuse can be used in conjunction with one or more screens (e.g., that serve as current collectors) and/or battery connectors. In certain embodiments, a miniature chip-type fuse can be located at one or more contact points between a battery and a device that is powered by the battery.

As an additional example, while a current collector including an elongated body and a fuse between two portions of the elongated body has been shown, in some embodiments, a current collector can have a different configuration. For example, in certain embodiments, a current collector may be formed entirely of a fuse, and may not include an elongated body that is separate from the fuse. In some embodiments, one or more of the leads extending from a fuse can be used as a current collector. The leads can be formed of one or more materials (e.g., metal alloys) that are not likely to react with the electrode active material with which the leads are in contact. In certain embodiments, a current collector can be formed of an elongated body and a fuse that is disposed at one end of the elongated body, rather than between two portions of the elongated body.

As a further example, while a fuse including a matrix has been described, in some embodiments, a fuse may not include a matrix. For example, in certain embodiments, a current collector can include a body (e.g., an elongated body), at least a portion of which is formed by a fusing element. In some embodiments, a current collector can be formed entirely of a fusing element.

All references, such as patent applications, publications, and patents, referred to herein are incorporated by reference in their entirety.

Other embodiments are in the claims.

What is claimed is:

1. A battery, comprising:
a housing;
an anode within the housing;
a cathode within the housing; and
a current collector at least partially disposed in the anode and comprising a fuse,
wherein the fuse comprises a fusing element having a melting point of at least about 200° C.

2. The battery of claim 1, wherein the fusing element has a melting point of at least about 400° C.

3. The battery of claim 1, wherein the fusing element has a melting point of at least about 800° C.

4. The battery of claim 1, wherein the fusing element has a melting point of about 800° C.

5. The battery of claim 1, wherein the fusing element has a melting point of at most about 2000° C.

6. The battery of claim 1, wherein the fusing element has a melting point of at most about 1100° C.

7. The battery of claim 1, wherein the current collector comprises an elongated body and the fuse is at least partially disposed in the elongated body.

8. The battery of claim 1, further comprising a sleeve supported by the current collector.

9. The battery of claim 8, wherein the sleeve contacts the current collector.

10. The battery of claim 8, wherein the sleeve comprises a material that is selected from the group consisting of plastics, ceramics, glasses, and combinations thereof.

11. The battery of claim 8, wherein the sleeve comprises a heat-shrinkable material.

12. The battery of claim 1, wherein the current collector comprises a metal or a metal alloy.

13. The battery of claim 1, wherein the current collector comprises brass.

14. The battery of claim 1, wherein the cathode comprises a nickel oxyhydroxide.

15. The battery of claim 1, wherein the battery is a primary battery.

16. Abattery, comprising:
a housing;
an anode within the housing;
a cathode within the housing; and
a current collector at least partially disposed in the anode and comprising a fuse comprising a fusing element,
wherein the fuising element is adapted to melt at a temperature of at least about 200° C. while the housing is at a temperature of at most about 90° C.

17. The battery of claim 16, wherein the fusing element is adapted to melt at a temperature of at least about 400° C. while the housing is at a temperature of at most about 90° C.

18. The battery of claim 16, wherein the fusing element is adapted to melt at a temperature of at least about 800° C. while the housing is at a temperature of at most about 90° C.

19. The battery of claim 16, wherein the fusing element is adapted to melt at a temperature of at least about 1000° C. while the housing is at a temperature of at most about 90° C.

20. The battery of claim 16, wherein the fusing element is adapted to melt at a temperature of at least about 200° C. while the housing is at a temperature of at most about 70° C.

21. The battery of claim 16, wherein the fusing element is adapted to melt at a temperature of at least about 200° C. while the housing is at a temperature of at most about 50° C.

22. The battery of claim 16, wherein the fusing element is adapted to melt at a temperature of at least about 200° C. while the housing is at a temperature of at most about 30° C.

23. The battery of claim 16, wherein the fusing element is adapted to melt at a temperature of at least about 200° C. while the housing is at a temperature of at most about 25° C.

24. A method of making a battery, the method comprising:
disposing an anode into a housing;
disposing a cathode into the housing; and
disposing a current collector into the housing,
wherein the current collector comprises an elongated body and a fuse at least partially disposed in the elongated body, the fuse comprising a fusing element having a melting point of at least about 200° C.

25. A method of making a battery, the method comprising:
disposing an anode into a housing;
disposing a cathode into the housing; and
disposing a current collector into the housing,
wherein the current collector comprises a fuse comprising a fusing element, and the fusing element is adapted to melt at a temperature of at least about 200° C. while the housing is at a temperature of at most about 90° C.

26. A method, comprising:
flowing a current through a battery comprising:
a housing;
an anode within the housing;
a cathode within the housing; and
a current collector at least partially disposed in the anode and comprising an elongated body and a fuse at least partially disposed in the elongated body, the fuse comprising a fusing element; and
increasing a temperature of the fusing element by at least about 100° C. while a temperature of the housing increases by at most about 80° C.

27. The method of claim 26, comprising increasing a temperature of the fusing element by at least about 300° C. while a temperature of the housing increases by at most about 80° C.

28. The method of claim 26, comprising increasing a temperature of the fusing element by at least about 500° C. while a temperature of the housing increases by at most about 80° C.

29. The method of claim 26, comprising increasing a temperature of the fusing element by at least about 900° C. while a temperature of the housing increases by at most about 80° C.

30. The method of claim 26, comprising increasing a temperature of the fusing element by at least about 100° C. while a temperature of the housing increases by at most about 50° C.

31. The method of claim 26, comprising increasing a temperature of the fusing element by at least about 100° C. while a temperature of the housing increases by at most about 30° C.

32. The method of claim 26, comprising increasing a temperature of the fusing element by at least about 100° C. while a temperature of the housing increases by at most about 10° C.

33. The method of claim 26, comprising increasing a temperature of the fusing element by at least about 100° C. while a temperature of the housing increases by at most about 5° C.

34. The method of claim 26, further comprising melting the fusing element.

35. The method of claim 34, wherein the fusing element melts at a current of at least about five amperes.

36. The method of claim 34, wherein the fusing element melts at a current of at most about 20 amperes.

37. The method of claim 34, wherein the fusing element melts after a current of about 10 amperes has been flowing through the fusing element for at least about 0.04 second.

38. The method of claim 37, wherein the fusing element melts after a current of about 10 amperes has been flowing through the fusing element for at most about one second.

39. The method of claim 34, wherein melting the fusing element comprises flowing a current of at least about five amperes through the fusing element for more than about 10 seconds.

40. The method of claim 34, wherein melting the fusing element comprises flowing a current of at least about five amperes through the fusing element for less than about 60 seconds.

41. The method of claim 34, wherein melting the fusing element comprises flowing a current of at most about 16 amperes through the fusing element for more than about 10 seconds.

42. The method of claim 34, wherein melting the fusing element comprises flowing a current of at most about 16 amperes through the fusing element for less than about 60 seconds.

43. A method, comprising:
increasing a temperature of a fusing element in a battery by at least about 100° C., the battery comprising:
a housing,
an anode within the housing,
a cathode within the housing, and
a current collector at least partially disposed in the anode and comprising an elongated body and a fuse at least partially disposed in the elongated body, the fuse comprising the fusing element,
wherein a temperature of the housing increases by at most about 80° C. while the temperature of the fusing element is increased by at least about 100° C.
